(19) United States
(12) Patent Application Publication
(10) Pub. No.: US 2008/0305358 A1
(43) Pub. Date: Dec. 11, 2008

(54) METHOD OF COATING A METALLIC SUBSTRATE

(76) Inventors: Jurgen Friederich Rudolph, Morstadt (DE); Jeffrey L. Stalker, Wexford, PA (US)

Correspondence Address: PPG INDUSTRIES INC;INTELLECTUAL PROPERTY DEPT, ONE PPG PLACE, PITTSBURGH, PA, 15272, US

(21) Appl. No.: 12/130,332

(22) Filed: May 30, 2008

Related U.S. Application Data
(60) Provisional application No. 60/942,293, filed on Jun. 6, 2007.

(51) Int. Cl. B32B 15/04; B05D 3/06; B05D 1/00; B05D 7/00

(52) U.S. Cl. 428/688; 427/508; 427/510; 427/511

(57) ABSTRACT

The present invention relates to a method of coating a metallic substrate comprising the steps of: (a) applying a liquid coating composition which comprises a thermally curable organic binding agent to at least part of the metallic substrate, and (b) curing the applied coating composition by irradiation with laser infrared light to form a cured coating on the substrate; and to coated metallic article obtainable thereby.

### BACKGROUND OF THE INVENTION

The present invention relates to a method of coating a metallic substrate comprising application of a coating composition and subsequent laser curing.

### FIELD OF THE INVENTION

The present invention relates to a method of coating a metallic substrate comprising application of a coating composition and subsequent laser curing.

### BACKGROUND INFORMATION

Automotive vehicle parts of the car body are manufactured mainly of zinc-coated steel showing up cut edges, box sections and hem flanges with increased corrosion sensitivity. The actual anticorrosion measures are a combination of pretreatment and secondary measures such as cavity wax, hem flange adhesive, hem sealer and electrocoating operations. In some cases the achieved status of corrosion protection is not sufficient, for example, because the protective materials cannot be applied completely without any voids or the material as such, e.g. the hem flange adhesive, undergoes rapid aging in corrosive climate. A further option to improve corrosion resistance is coil coating of the steel sheets. In a coil coating process an organic coating is applied to the steel sheet on coil coating lines of the automotive steel suppliers. Although a coil-coated steel sheet that is used in an automotive car body assembling process shows considerably improved corrosion resistance at hem flanges and box sections, coil coating does not result in a protection of the cut edges. Moreover, coil-coated steel is very expensive and thus mainly used for the production of premium class vehicles. The economic viability of the coil coating is further reduced by the fact that about 40% of the coil-coated steel is wasted because scrap is unavoidable during assembling and cutting of vehicle parts. Additional amounts of the applied organic coating are on the plane of the steel surface where they have no additional benefit for corrosion protection.

It is thus the object of the present invention to provide a new and economic method of coating metallic substrates. In case of anticorrosive coatings there is a demand for an effective method to impart improved corrosion resistance to inaccessible areas, for example of automotive bodies, with increased corrosion sensitivity, such as box sections and hem flanges, which is less expensive than coil coating of the steel sheets.

### SUMMARY OF THE INVENTION

The present invention is directed to a method of coating a metallic substrate comprising the steps of: (a) applying a liquid coating composition which comprises a thermally curable organic binding agent to at least part of the metallic substrate, and (b) curing the applied coating composition by irradiation with laser infrared light to form a cured coating on the substrate.

The present invention is further directed to a coated metallic article obtainable according to said method.

### DETAILED DESCRIPTION OF THE INVENTION

In step (a) a coating composition which comprises a thermally curable organic binding agent is applied to at least part of the metallic substrate. In principle, any method useful to coat a metallic substrate can be employed, e.g. dipping spraying, roller coating, and bar coating. However, the method of the present invention is especially advantageous and economical if only those areas of a metallic substrate are coated that require the coating. Thus, according to a preferred embodiment of the present invention, the coating composition is only applied to selected areas of the metallic substrate in step (a) and only said areas are irradiated with laser infrared light in step (b). It is understood that the “only said areas” may include areas directly adjacent to the coated area.

In step (a) the coating composition can be applied to selected areas by any method for precision application of coatings. Preferably, the precision coating method fulfils one or more of the following requirements: no or low amount of overspray, ultra small droplet size, and a precise volume flow.

The shape of the paint pattern obtained by the precision coating method is not critical for the present invention; it rather depends from the type of coating composition applied and the purpose of the resulting coating. A typical paint pattern, especially in the field of anticorrosive coatings for automobiles, has a thickness of from 3 to 7 μm, preferably from 4 to 6 μm. A typical width of the paint pattern is from 1 to 20 mm.

In one embodiment the coating composition is provided by a supply means, e.g. a nozzle, that is moved over the substrate to be coated. Typical propagation speeds are from 1 to 20 m/min.

Illustrative examples of precision coating methods are ink-jet printing, airbrushing, ultrasonic spray coating, and any other spraying methods used in combination with a mask in order to protect areas that should not be covered by the coating.

Ink-jet printing is a coating method well-known to the person skilled in the art. It is a contactless coating method which can be controlled digitally. The control is adjustable very precisely and the placement of the droplets is point-to point. Ink-jet printing provides the feasibility to apply thin films at a few microns with constant thickness and width at very high accuracy in the range of ±0.1 μm.

For example, in order to obtain a coating pattern having a length of 300 cm, a thickness of 6 μm and a width of 2 cm a propagating print head requires a paint stream of 6 μl/s at 3 m/min. Examples of resulting paint streams depending on spraying speed and pattern length are given below.

| | Speed | Pattern | Req paint | paint |
|---|---|---|---|---|
| Spraying speed | [m/min] | length [cm] | [μl/min] | μl/sec |
| low speed | 1 | 100 | 120.00 | 2.00 |
| low speed | 3 | 300 | 360.00 | 6.00 |
| medium speed | 5 | 500 | 600.00 | 10.00 |
| fast speed | 10 | 1000 | 1200.00 | 20.00 |
| very fast speed | 20 | 2000 | 2400.00 | 40.00 |

Ultrasonic spray coating is a coating method well-known to the person skilled in the art. It is the precise application of a paint employing ultrasonic energy, typically by means of an ultrasonic nozzle. The paint is atomized by a high-frequency ultrasonic field and the spray mist is applied to the substrate in the form of a thin jet. The droplet size can be controlled by adjusting the frequency of the ultrasound and the thickness of the resulting wet film of paint can be controlled by adjusting the discharge rate.

Airbrushing is a coating method well-known to the person skilled in the art. An airbrush is an atomizer, typically in the form of a spray gun, that sprays paint by means of compressed air. If desired, the surrounding area not to be coated by the paint may be covered with a mask, e.g. a magnetic foil. The resulting film thickness increases linear with each spray wipe. Generally, several (e.g. at least 10) wipes are required to achieve a close and dense coating pattern. Typical airbrushing parameters are: spray pressure from 1.0 to 4.0 bar and paint flow from 0.1 to 1.0 ml/min.

In step (b) a laser beam is directed to the coating applied to the substrate to provide sufficient heat for the curing process. Typically, the laser beam moves with a certain propagation speed over the coating to be cured. The curing by irradiation with laser infrared light (LIR) replaces conventional oven cure. Contrary to the latter, LIR-curing is a very fast and efficient heating process. The substrate is heated only locally where coating composition has been applied. The heating source, i.e. the laser, can be switched on and off, thus it only works when heat is needed and the heating power can be adjusted by easy computer control. The movement of the laser beam is very fast when attached to a motor driven robot arm or deflected by an optical mirror system and speed is only limited by the curing properties of the coating composition. Preferably, the coated substrate is irradiated with a non-focused laser beam. The person skilled in the art can readily determine the parameter settings of the laser, e.g. propagation speed and laser power, to achieve sufficient cure between over bake and under bake conditions.

Typical examples of laser sources are diode lasers, CO₂ lasers and solid lasers. Because of its high output power and because of its shorter wavelength compared to CO₂ lasers, solid state lasers are preferably used in automotive industry. Solid state lasers are lasers based on solid state gain media such as crystals or glasses doped with rare-earth or transition-metal ions, or semiconductor lasers. Ion-doped solid state lasers can be made in the form of rod lasers, fiber lasers, disk laser or other types of waveguide lasers. Preferred lasers suitable for the process of the present invention are summarized as follows.

| Solid state laser | Gain media | Wavelength | Prefered form |
|---|---|---|---|
| Neodym-YAG- | Nd:YAG | 1.064 μm | Rod laser |
| Laser | | | |
| Neodym-Glas | Nd:Glas | 1.060 μm | Rod laser |
| Ytterbium-YAG | Yb:YAG | 1.030 μm | Disk laser |
| Ytterbium-Glas | Yb:Glas | 1.050 μm | Fiber laser |

YAG = Yttrium-Aluminium-Granat

Preferably, the wavelength of the LIR is in the range of from 800 to 1200 nm, more preferably of from 950 to 1100 nm, most preferably of from 1000 to 1075 nm. The irradiation with LIR allows the heating of the applied coating film and the substrate within a short time. As in a thermal process the coated substrate is brought to the required temperature to cause curing, i.e. crosslinking of the applied film. The critical parameter for the film crosslinking is the curing temperature and more precisely, the maximum temperature reached by the metallic substrate which is called peak metal temperature (PMT). The required amount of heat can be determined according the equation

Q=mCᵥdT,

wherein

Q=amount of heat,

m=mass of the irradiated metallic substrate

Cᵥ=heat capacity of the metallic substrate

dT=temperature difference.

Due to the short heat up times that are generally employed the required heating power is high (P=Q/t). Short heat up times allow a high propagation speed of the laser beam.

As an example, the amount of heat required to locally heat a steel panel (Cv=480 J/kg/K; δ=7.8 g/cm³; thickness=0.8 mm) from 20 to 170° C. with a laser beam having a diameter of 2 cm is about 141 J. Table 1 shows the required heat up power depending from the propagation speed (correlating to the heat up time).

TABLE 1

| Propagation | | | |
|---|---|---|---|
| speed [m/min] | heat up time [s] | Amount of heat [J] | power [W] |
| slow: 5.00 | 0.24 | 141 | 588 |
| medium: 10.00 | 0.12 | 141 | 1175 |
| fast: 25.00 | 0.048 | 141 | 2938 |
| fast: 50.00 | 0.024 | 141 | 5875 |

In this example a heat up time of 0.24 s corresponds to a heat up rate of 37.500 K/min which is much faster compared to a heat up rate of a panel in a conventional oven of about 300 K/min.

Typically, the laser power is in the range of from 0.5 to 10 kW, preferably 1 to 10 kW. Typical scanning speeds range from 1 to 20 m/min.

In a preferred embodiment of the present invention a deoiling and/or cleaning step is performed prior to step (a), the application of the coating composition. The deoiling and/or cleaning step is preferably done by pulsed laser radiation. Deoiling means evaporation of liquid oil from the substrate surface. Focused pulsed laser light has sufficient power to vaporize coatings and surface layers from metal surfaces. The ultra short laser pulses remove oil, dirt and other contamination layers without damage or thermal impact to the metallic substrate. Especially suitable for cleaning are pulsed lasers of different wavelengths, such as CO₂-TEA, q-switched Nd:YAG or excimer lasers. For a few applications, the use of continuous wave CO₂ lasers is possible. Each laser creates a different process on the surface. The “classic” amongst the cleaning lasers is the pulsed CO₂-TEA laser. It emitts short laser pulses (duration μs-ms) with high pulse energy (several Joules). The pulsed light hits the surface with peak powers of up to 100 million Watt. The energy applied suddenly can not dissipate and blasts off part of the coating. The target zone is the size of the laser beam spot on the surface (app. 1 cm²) and has a depth of up to 1/100 mm. By repeating this process up to several hundred times per second, a surface can be decoated pulse by pulse.

The laser system that is used to cure the coating in step (b) can also be used to weld the metallic substrate in a preliminary or subsequent step, if desired. The laser system may be operated by two different working modes for either laser curing or laser welding without modifying the laser optic or sample tooling. Whereas laser curing is preferably done by irradiating with a non-focused laser beam, laser welding is typically done by irradiating with a focused laser beam.

It is especially advantageous to do steps (a) and (b) and optionally the preliminary deoiling/cleaning step and/or welding step of the method according to the present invention by means of a single unit, typically a robot, which is equipped with a coating device, preferably a precision coating device, and a suitable laser system, for example having a beam collimating laser optic. An accordingly equipped computer-controlled robot results in a production unit that especially fits in modern automotive body assembly lines.

In principle, any coating composition comprising a thermally curable organic binding agent can be used in the present method. As mentioned above, some areas of the car body, such as cut edges, box sections and hem flanges, have increased corrosion sensitivity. As the method according to the present invention is especially adapted to coat selected areas of a substrate, a preferred type of coating composition for use in the present method is an anticorrosive primer.

Other examples for coating compositions that may require an application to only selected areas are fire retardant coatings, heat deflective coatings, sound dampeners (Audioshield®), Audiogard®), barrier coatings (Bairocate® oxygen barrier coatings), electrically isolating coatings (against galvanic corrosion, Bonazinc® 2000), antistatic coatings, EMI (electromagnetic interference) shield coatings, soft coatings (to provide anti-chip properties) or anti-abrasive coating for reducing die wear during stamping and forming (organic coatings which contain MoS, graphite or zinc pigments to reduce surface friction).

As the power output of a laser is limited and in order to avoid stresses in the substrate due to different temperatures (the temperature of the substrate areas adjacent to the LIR irradiated areas is considerably lower) the use of a low cure coating composition is preferred in the present method. Typically, low cure coating compositions cure at a peak metal temperature (PMT) in the range of from 50 to 250° C. Preferably, the PMT is in the range of from 80 to 250° C., more preferably from 100 to 180° C., even more preferably from 160 to 180° C., and most preferably the PMT is no higher than 170° C.

The binding agent contained in the coating composition that can be used in the present invention may be any thermally curable organic binding agent. Preferably, the binding agent is a thermally crosslinkable organic binding agent that is cured by reaction with a crosslinking agent (curing agent). Thus, in a preferred embodiment the coating composition for use in the present method further comprises a crosslinking agent. The crosslinkable binding agent carries functional groups that are reactive with the functional groups of the crosslinking agent.

Illustrative examples of suitable crosslinkable binding agents are polymers comprising functional groups selected from blocked and unblocked isocyanates, polyesters, epoxy-containing materials, phenoxy-containing materials, and mixtures thereof.

The curing agent can be selected from aminoplasts, polyisocyanates, polyacids, organometallic acid-functional materials, polyamines, polyamides and mixtures of these, depending on the functional groups present in the binding agent. Various curing agents are described in US 2004/0084657 A1 which is hereby incorporated by reference. The selection of the appropriate curing agent(s) is well within the skills of those practicing in the art. A preferred binding agent is a polymer comprising blocked isocyanate groups that is crosslinked with a polyol.

Depending on the purpose of the coating applied to the substrate the coating composition comprises additional ingredients customary in the state of the art, e.g. corrosion resistant pigments, IR radiation absorbing pigments, conductive pigments, diluents such a water and organic solvents, dispersants, thickeners, stabilizers, rheology modifiers, anti-settling agents, surfactants, and inorganic lubricants. Various additives including examples are described in US 2004/0084657 A1 which is hereby incorporated by reference.

In one embodiment the coating composition for use in the present method comprises water or a highly volatile organic solvent, preferably a solvent having a boiling point of less than 100° C. The use of aqueous or fast drying coating compositions avoids or minimizes the risk of fire which may exist when the laser beam is applied to a coating still comprising residual amounts of inflammable solvent.

Suitable IR radiation absorbing pigments are obtainable from Merck KGaA Darmstadt Germany such as Minatec® 230 A-IR.

The amount and type of conductive pigments contained in the coating composition determine whether a coating is weldable or not. Weldable coating compositions comprise higher amounts of conductive pigments whereas coating compositions that are no longer weldable but still conductive enough to allow application of a further layer by electrodeposition comprise lower amounts of conductive pigments.

If it is intended to weld the metallic substrate after curing of the applied coating the cured coating should be weldable. Preferably, the coating composition for use in the present method is a weldable low-cure anticorrosive primer. An example of a suitable weldable low-cure anticorrosive primer is described in US 2004/0084657 A1 which is hereby incorporated by reference.

It is understood that the coating composition should be adapted to the application method used in step (a). Illustrative properties of the coating composition that may be selected depending from the desired application method are viscosity, solids content, maximum particle size of pigments, and surface tension. It is within the normal skill of an expert to select and adjust the properties by some routine experiments.

In one embodiment, the metallic substrate to be coated may be pretreated, for example by a chrome-free pretreatment such as a titanium, zirconium, silane or zinc phosphate (prephosphate) containing no-rinse primer (e.g. Nupal® 456 BZR, available from PPG Industries, Pittsburgh, U.S.A.; Chemfos® 2007 (Dry-In-Place Zinc Posphate) available from PPG Industries Italia S.p.A., Quattordio (AL), Italy, and Granodine® 1456 available from Henkel KGaA, Duesseldorf, Germany, in order to improve the adhesion to the coating applied in step (a). In some cases it may be desired to pretreat the metallic substrate by electrodeposition. In this case, using a low cure coating composition in the present method—in combination with the short laser curing times—will allow curing of the applied coating without damaging the underlying electrodeposited coat. However, the metallic substrate coated by the present method is preferably not pretreated.

Any metallic substrate that can sustain the LIR irradiation in step (b) can be coated by the present method. Metal substrates used in the practice of the present invention include ferrous metals, non-ferrous metals and combinations thereof. Suitable ferrous metals include iron, steel, and alloys thereof. Non-limiting examples of useful steel materials include cold-rolled steel, galvanized (zinc coated) steel, electrogalvanized steel, stainless steel, high strength steel, bake-hardenable steel, pickled steel, zinc-iron alloys such as Galvanneal, Galvalume and Galfan zinc-aluminum alloys and combinations thereof. Useful non-ferrous metals include aluminum, zinc, magnesium and alloys thereof, e.g. aluminum alloys. Combinations or composites of ferrous and non-ferrous metals can also be used. If the metallic substrate is or will become part of an automotive body the preferred substrate material is galvanized steel such a electrogalvanized steel, hot dip galvanized steel and galvannealed (=hot dip galvanized and annealed) steel.

The coating method of the present invention may be performed at different stages of the production process of a vehicle or any other article made of assembled metal parts. The coating composition may be applied to the flat blanks (either the blanks before cutting or the cut blanks), tailored blanks, tailored tubes, the drawn and formed parts, or the assembled (including preassembled) parts. Application of the coating composition to the metallic substrate prior to any assembling steps is typically performed on selected areas which will become part of a hem flange or box section after later assembling steps. It is understood that the application to the flat blanks (prior to or after cutting) is easier than the application to the drawn and formed parts since the robot application in the latter case requires a more efficient computer control to consider the three dimensional body shape of the parts. This is also afforded when selected areas of preassembled parts such as weld seams or cut edges are protected by the present method. The coating method of the present invention may also be applied to selected areas of an already assembled article such as an automotive body. Illustrative areas include box cavities and hem flanges where the resulting coating can replace the standard PVC hem sealer and/or add protection where it is difficult to apply PVC hem sealer or cavity wax.

In a preferred embodiment the metallic substrate that is coated according to the method of the present invention is or will become a part of an automotive body. If anticorrosive primer is selectively applied to corrosion sensitive areas of the automotive body, such as hem flanges and box sections, the present method considerably reduces the costs of anticorrosion measures in automotive production compared to coil coating of the complete metal sheets. The present method may significantly improve resistance to crevice corrosion. If anticorrosive primer is applied to cut edges of an automotive body it imparts corrosion resistance to these areas which cannot be protected by coil coating.

It is understood that the present method is not restricted to the coating of parts of an automotive body, but can equally be applied in other technical fields, typically where precision application of a coating is desired. Illustrative examples are the production of printed circuit boards, household appliances, and aircraft.

The following examples are intended to illustrate the invention, and should not be construed as limiting the invention in any way.

### EXAMPLES

### Examples 1 to 4

### Airbrush Pattern on Pretreated Panels

Two-sided DC04 Electrogalvanized steel (EG) 75/75, 8 mm thick, was obtained from ThyssenKrupp Steel (TKS), Salzgitter AG, Arcelor-Mittal steel and Voestalpine. Each panel was 10 cm wide and 20 cm long. The steel panels were subjected to an alkaline cleaning process by immersion dip in a 0.85% by weight bath of Ridoline® 72 (available from Henkel KGaA, Duesseldorf, Germany) at a temperature of 60° C. for 10 s. The panels were removed from the alkaline cleaning bath, rinsed with deionized water at about 21° C. for 5 s and dried with warm air (60° C.).

After cleaning the panels were coated with a 3 weight % solids solution of Nupal® 456 BZR (chromium-free chemical pretreatment composition available from PPG Industries, Pittsburgh, U.S.A.). The solution was applied via spin coater application (600 rpm, 30 s) and baked for 15 s until a peak metal temperature (PMT) of 100° C. was achieved. The coating weight was from 80 to 100 mg/m².

The panel was subsequently coated via airbrushing with a weldable primer Bonazinc® LC (solvent-borne zinc rich primer comprising an epoxy urethane binder and available from PPG Industries, Inc., Pittsburgh, U.S.A.) at 6-7 μm (compressor: aero-pro/HTC 20A (Art.-Nr. 230200), applied spray pressure 3.5 bar, nozzle: Evolution Silverline, nozzle orifice 0.2 mm) until the spray pattern was uniformly closed (10 wipes). Prior to primer paint application the primer was thoroughly thinned by adding 20 weight % of methoxy propyl acetate in order to reduce its viscosity from 80 to less than 20 seconds (#4 Ford cup). In order to achieve a straight pattern the panels were masked by using magnetic foil. The magnetic foil of the size 4×20 cm left a stripe of 2.0×20 cm uncovered.

Flat panels which were prepared and coated as described above were subjected to a short laser cure operation. A widened laser beam (Nd:YAG laser, Trumpf HL 4002, δ32 1030 nm, beam diameter 20 mm) with a propagation speed of 3 m/min and operated at a laser power of 2 kW was used to heat up the primer pattern to 170° C. PMT and cure it.

The coated panels were compared to an oven cured sample in standard adhesion testing according to DIN EN 13523-6 and corrosion testing according to DIN EN 15523-8. The results are shown in Table 2.

TABLE 2

| | | | | | Com- |
|---|---|---|---|---|---|
| | | | | | parison |
| | Example No. | | | | Ex- |
| | 1 | 2 | 3 | 4 | ample |
| Supplier of steel | TKS | Arcelor | Salzgitter | Voestalpine | TKS |
| Thickness of | 6 μm | 6 μm | 6 μm | 6 μm | 4 μm |
| primer layer | | | | | |
| Type of curing | LIR | LIR | LIR | LIR | oven |
| | | | | | cure¹ |
| No. of MEK rubs | >50 | >50 | >50 | >50 | >50 |
| ASTM D4752-03 | | | | | |
| Erichsen adhesion | 0-1 | 0-1 | 0-1 | 0-1 | 0-1 |
| DIN EN 13523-6 | | | | | |
| Salt spray test (red | 1-5% | 1-5% | 1-5% | 1-5% | 1-5% |
| rust after 250 h)² | | | | | |
| DIN EN 15523-8 | | | | | |

¹oven temperature 350° C.; dwell time 30 s; PMT 170° C.
²uncoated areas were taped with adhesive foil

As seen in Table 2 the laser cured coatings of the present invention have adhesion and corrosion resistance comparable to that of a standard baked coating.

### Example 5

### Laser Weld Seam Protection

A flat steel panel (DC04 Electrogalvanized steel (EG) ThyssenKrupp Steel as in Ex. 1), which was 10 cm wide and 20 cm long, was subjected to a laser welding operation. The laser seam was written with a focused laser beam which was attached to an automated robot arm and controlled by a computer program (Trumpf HL 4002, Nd:YAG, δ=1030 nm, beam focus diameter 0.5 mm, focal position+0.5 mm) The seams were written with a propagation speed of 5 m/min and 4 kW laser power.

After the panel was treated by the laser beam, liquid and adherent protection oil was vaporized in a small pattern beside the laser seam. The laser weld seam and adjacent area were spray coated with Bonazinc® LC at 5-6 μm by airbrushing as described in Ex. 1 to 4 until the spray pattern was uniformly closed (10 wipes). Prior to primer paint application the primer was thoroughly thinned by adding 20 weight % of methoxy propyl acetate in order to reduce its viscosity from 80 to less than 20 seconds (#4 Ford cup).

Flat panels which were prepared and coated as described above were subjected to a short laser cure operation. A widened laser beam (Trumpf HL 4002, Nd:YAG, δ=1030 nm, beam diameter 20 mm) with a propagation speed of 3 m/min and operated at a laser power of 2 kW was used to heat the primer pattern up to 170° C. PMT and cure it.

### Example 6

### Cut Edge Protection

Two-sided electrogalvanized steel (EG) as in Ex. 1 was obtained from ThyssenKrupp Steel. Each steel panel was 10 cm wide and 20 cm long. The steel panels were subjected to an alkaline cleaning process by immersion dip in a 0.85% by weight bath of Ridoline® 72 (available from Henkel KGaA, Duesseldorf, Germany) at a temperature of 60° C. for 10 s. The panels were removed from the alkaline cleaning bath, rinsed with deionized water at about 21° C. for 5 s and dried with warm air (60° C.).

After cleaning the panels were coated with a 3 weight % solids solution of Nupal® 456 BZR. The solution was applied by roll coating (40 psi, 210 rpm) and baked for 15 s until a PMT of 100° C. was achieved. The coating weight was from 80 to 100 mg/m²

The entire panels were subsequently coated via roll coating (transport roll 55 m/min, applicator roll 60 m/min 110%, pick up roll 11 m/min, 20%) with Bonazinc® LC at 4 μm.

The coated panels were trimmed at size 10×10 cm fixed with an 2 cm overlap and the gab between these two panels was kept open with metal distance foil at 0.1 mm. The overlapping metal sheets were joined by laser beam welding.

The unprotected cut edges were subsequently coated by airbrushing with Bonazinc® LC at 5-6 μm as described in Ex. 1 to 4 until the spray pattern was uniformly closed (10 wipes). Prior to primer paint application the primer was thoroughly thinned by adding 20 weight % of methoxy propyl acetate in order to reduce its viscosity from 80 to less than 20 seconds (#4 Ford cup).

A widened laser beam (Trumpf HL 4002, Nd:YAG, δ=1030 nm beam diameter 20 mm) with a propagation speed of 3 m/min and operated at a laser power of 2 kW was used to heat up the primer pattern to 170° C. PMT and cure it.

### Example 7

### Ultrasonic Spray

Two-sided electrogalvanized steel (EG) as in Ex. 1 was obtained from ThyssenKrupp Steel. The steel panels were subjected to an alkaline cleaning process by immersion dip in a 0.85% by weight bath of Ridoline® 72 at a temperature of 60° C. for 10 s. The panels were removed from the alkaline cleaning bath, rinsed with deionized water at about 21° C. for 5 s and dried with warm air (60° C.).

After cleaning the panels were coated with a 3 weight % solids solution of Nupal® 456 BZR. The solution was applied by roll coating (40 psi, 210 rpm) and baked for 15 s until a PMT of 100° C. was achieved. The coating weight was from 80 to 100 mg/m²

A precision coating pattern was applied by using a Sono-TEK ultrasonic generator (atomizer) with an ultrasonic spray nozzle #04068. Air flow was adjusted to 4 psi and the output voltage was set to 2 W to achieve a homogenous spray mist. The spray pattern was about 10 mm wide and had a dry film thickness of about 5-6 μm. The distance to the panels was kept constant at 10 mm. A homogenous film thickness was achieved by using a motor driven x-y table. Its propagation speed was 1 m/min.

Flat panels which were prepared and coated as described above were subjected to a short laser cure operation. A widened laser beam (Trumpf HL 4002, Nd:YAG, δ=1030 nm, beam diameter 20 mm) with a propagation speed of 3 m/min and operated at a laser power of 2 kW was used to heat up the primer pattern to 170° C. PMT and cure it.

1. A method of coating a metallic substrate comprising the steps of
(a) applying a liquid coating composition which comprises a thermally curable organic binding agent to at least part of the metallic substrate, and
(b) curing the applied coating composition by irradiation with laser infrared light to form a cured coating on the substrate.

2. The method of claim 1, wherein the coating composition is applied to only selected areas of the metallic substrate in step (a) and only said areas are irradiated with laser infrared light in step (b).

3. The method of claim 1, wherein in step (a) the coating composition is applied by ink-jet printing, airbrushing, or ultrasonic spray coating.

4. The method of claim 1, wherein at least part of the metallic substrate is deoiled and/or cleaned by means of pulsed laser light prior to step (a).

5. The method of any of claim 1, wherein the metallic substrate is a pretreated metallic substrate.

6. The method of claim 1, wherein at least part of the metallic substrate is subjected to laser welding prior to step (a) or after step (b).

7. The method of claim 1, wherein the coating composition applied in step (a) is an anticorrosive primer.

8. The method of claim 1, wherein the coating composition applied in step (a) is a low cure coating composition which cures at a peak metal temperature in the range of from 50° C. to 250° C.

9. The method of claim 8, wherein the peak metal temperature is in the range of from 100° C. to 180° C.

10. The method of claim 1, wherein the metallic substrate is selected from steel and aluminum alloys.

11. The method of claim 10, wherein the metallic substrate is galvanized steel.

12. The method of claim 2, wherein the coating composition is applied to the metallic substrate on selected areas which will become part of a hem flange or box section after later assembling steps.

13. The method of claim 2, wherein the coating composition is applied to the cut edge(s) of a metallic substrate.

14. The method of claim 1, wherein the metallic substrate is selected from blanks, cut blanks, tailored blanks, tailored tubes, drawn and formed parts, and assembled parts.

15. The method of claim 1, wherein the metallic substrate is or will become a part of an automotive body.

16. The method of claim 1, wherein steps (a) and (b) and optionally, the preliminary deoiling/cleaning step and/or the laser welding step are performed by a single robot.

17. A coated metallic article obtainable by the method of claim 1.
